(19) United States
(12) Patent Application Publication
(10) Pub. No.: US 2018/0204524 A1
(43) Pub. Date: Jul. 19, 2018

(54) CONTROLLING BRIGHTNESS OF AN EMISSIVE DISPLAY

(71) Applicant: Microsoft Technology Licensing, LLC, Redmond, WA (US)

(72) Inventors: Jan Kucera, Prague (CZ); John Franciscus Marie Helmes, Steyl (NL); Nicholas Yen-Cherng Chen, Cambridge (GB); Tobias Grosse-Puppendahl, Cambridge (GB); James Scott, Cambridge (GB); Stephen Edward Hodges, Cambridge (GB); Stuart Taylor, Cambridge (GB); Matthias Baer, Seattle, WA (US)

(21) Appl. No.: 15/410,738

(22) Filed: Jan. 19, 2017

(51) Int. Cl. G09G 3/34; G09G 3/20

(52) U.S. Cl. CPC G09G 3/3406; G09G 3/2003; G09G 2320/0242; G09G 2320/0633; G09G 2360/144

(57) ABSTRACT

A method of operating an emissive display is described in which an ambient light level is detected using a light sensor. If the detected ambient light level is in a predefined region, the method comprises setting a backlight level to a minimum level, generating a correction factor based on the detected ambient light level and modifying color values of content to be displayed using the correction factor.

### BACKGROUND

Emissive displays (e.g. LCD or LED displays) are becoming increasingly present in the environment. Such displays require power to display content and emit light when the display is on. The emission of light makes these displays visually intrusive in certain environments (e.g. in a bedroom at night) unlike, for example, a painting, a poster or wallpaper.

The embodiments described below are not limited to implementations which solve any or all of the disadvantages of known emissive displays.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A method of operating an emissive display is described in which an ambient light level is detected using a light sensor. If the detected ambient light level is in a predefined region, the method comprises setting a backlight level to a minimum level, generating a correction factor based on the detected ambient light level and modifying color values of pixels using the correction factor.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a system comprising a computing device and a display device which operates in calm mode;

FIG. 2 is a flow diagram of an example method of operation of an emissive display device, such as the display device shown in FIG. 1;

FIG. 3 is an alternative representation of the method shown in FIG. 2;

FIG. 4 shows a schematic diagram showing example chromaticity calibration data points and a schematic diagram showing the RGB primaries of an ambient light sensor;

FIG. 5A shows a flow diagram of an example method of performing chromaticity matching;

FIG. 5B shows a graphical representation of a chromaticity matching operation which uses the chromaticity calibration data;

FIG. 6 comprises a schematic diagram showing an example of brightness calibration data;

FIG. 7 is a flow diagram of an example method of generating brightness calibration data such as shown in FIG. 6;

FIG. 8A shows a schematic diagram of a first hardware arrangement which may be used when generating brightness calibration data using the method of FIG. 6 and/or when generating chromaticity calibration data using the method of FIG. 9;

FIG. 8B shows a schematic diagram of a second hardware arrangement which may be used when generating brightness calibration data using the method of FIG. 6 and/or when generating chromaticity calibration data using the method of FIG. 9;

FIG. 9 is a flow diagram of an example method of generating chromaticity calibration data;

FIG. 10 shows schematic diagrams of a display device, such as shown in FIG. 1, in which parts of the display operate according to the method of FIG. 2 and other parts do not;

FIG. 11 shows a graphical representation of the first and second regions;

FIG. 12 shows a graphical representation of an example implementation which uses four regions; and

FIG. 13 is a flow diagram of another example method of operation of an emissive display device, such as the display device shown in FIG. 1.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

As described above, the emission of light makes emissive displays visually intrusive in certain environments, such as in a bedroom at night or in a theatre or cinema or other environments with low light levels (e.g. because the emissive displays glow brightly). Even in more brightly lit environments, such displays are more obtrusive than a piece of paper attached to a wall or noticeboard and this may result in information overload.

Described herein is a method of operating a display device that varies the brightness and chromaticity of the display dependent upon the ambient light, such that the displayed content more closely resembles content displayed on paper. Using the methods described herein, the brightness range of an emissive display is extended (e.g. compared to known emissive displays or to the same emissive display where the methods described herein are not implemented) to enable the brightness and chromaticity of the display to be more closely matched to paper over a larger range of ambient light levels. This makes the emissive display less visually intrusive. In particular, the methods described herein enable the brightness and chromaticity of the display to be more closely matched to paper at darker ambient light levels. This makes the emissive display less visually intrusive at such darker ambient light levels and more generally, reduces the power consumption of the emissive display (e.g. compared to known emissive displays or to the same emissive display where the methods described herein are not implemented).

When operated using the methods described herein, the display device may be described as a ‘calm’ display device because it is not obtrusive and may fade into the background from the perspective of a viewer (e.g. unlike a standard emissive display which glows brightly and hence attracts the attention of a viewer). In examples where the display device does not operate using the methods described herein all of the time, the display device may be described as having a ‘calm mode’. When operating in calm mode, the display device implements the methods described herein.

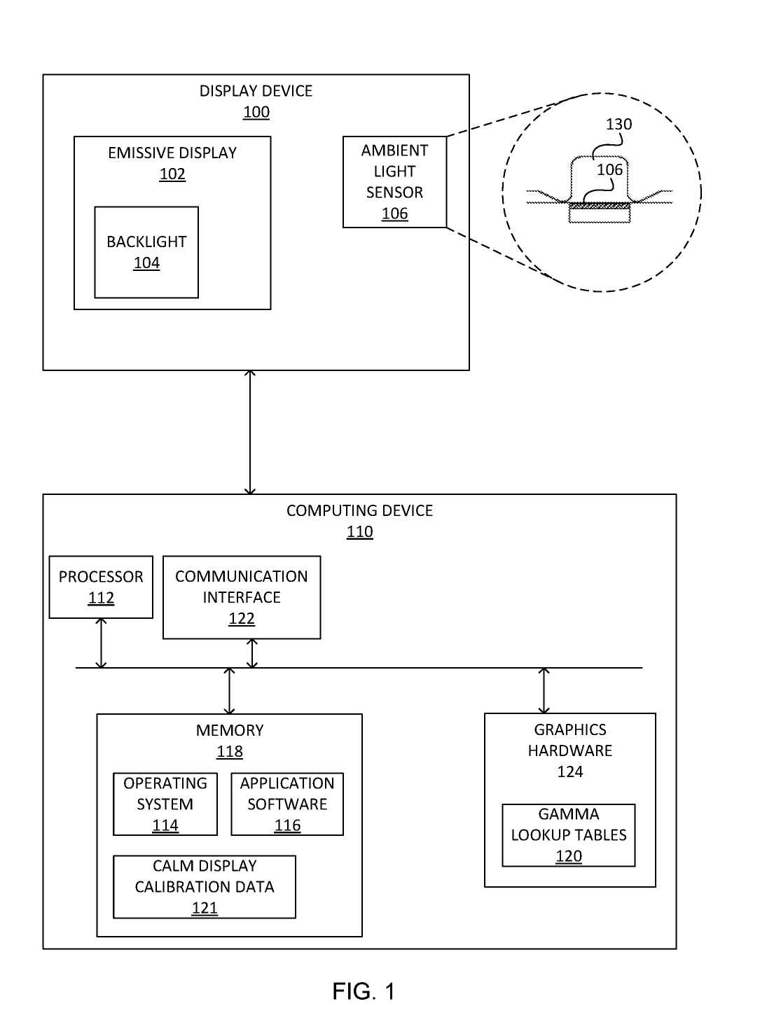

FIG. 1 is a schematic diagram of a display device 100 connected to a computing device 110. The system shown in FIG. 1 (comprising the display device 100 and computing device 110) is configured such that the computing device 100 generates calm display information for rendering on the display device 100 some or all of the time. When the display device 100 renders calm display information, the display device 100 may be described as operating in a calm mode. The display device 100 displays content provided by the computing device 110 and it will be appreciated that the display device 100 may be connected via a wired or wireless connection to the computing device 110 which may be geographically co-located with the display 100 or geographically separated from the display 100. The connection between the two entities 100, 110 may be a direct connection (e.g. via a lead or wireless link) or may be via a network (e.g. via a LAN and/or the internet).

The display device 100 comprises an emissive display 102 (which comprises a backlight 104) and an ambient light sensor 106. The display device 100 may be a standalone display device or may be integrated into another device (e.g. the computing device 110, a home appliance, etc.). Although the ambient light sensor 106 is shown within the display device 100, it will be appreciated that in other examples, the ambient light sensor 106 may be separate from the display device 100 but positioned on, or very close to, the front (i.e. the surface displaying the content) of the display device 100 (e.g. close to the emissive display 102). Although FIG. 1 shows a single ambient light sensor 106, in other examples there may be more than one ambient light sensor 106 (e.g. for larger displays where lighting conditions may vary across the display). In various examples the ambient light sensor(s) may be embedded within the display, e.g. with an ambient light sensor underneath some or all of the pixels in the display.

The ambient light sensor 106 is arranged to obtain light levels (e.g. intensities) at a plurality of different, pre-defined wavelengths (or wavelength ranges) at the same point in time, where each of these pre-defined wavelengths or wavelength ranges may be referred to as a channel. In various examples the ambient light sensor 106 may be arranged to obtain light levels at three or more different, pre-defined wavelengths (or wavelength ranges), e.g. one corresponding to each of the red, green and blue channels, at the same point in time. By obtaining light levels for all of the channels at the same point in time, color flickering artifacts, which might otherwise occur as a consequence of false color readings during lighting changes, can be avoided. The ambient light sensor 106 may, for example, comprise a single sensor (e.g. which can detect the separate colors) or multiple sensors (e.g. three sensors, one for each of the red, green and blue channels). The ambient light sensor 106 may comprise one analog-to-digital converter (ADC) and multiple sample and hold circuits to enable light levels to be obtained for the red, green and blue channels at the same point in time. Alternatively, the ambient light sensor 106 may comprise multiple (e.g. three) ADCs such that all color channels can be read simultaneously. In various examples, the ambient light sensor 106 may additionally comprise a fourth channel (and optionally a fourth ADC), the clear channel, which may be used in calibration, as described below.

In contrast, to paper (which has a relatively uniform angular response, scattering incoming light in all directions), many RGB sensors are particularly sensitive to perpendicular light (i.e. light incident at 90° to the surface of the sensor 106) and so a system which is calibrated using perpendicular light may be too dim when the incident ambient light comes from an oblique angle. In various examples the ambient light sensor 106 may comprise a means for reducing the sensitivity of the sensor to the angle of incident light, such as an enclosure 130 which attenuates perpendicular light and an example arrangement is shown in FIG. 1. The enclosure 130 (which may be 3D printed) covers the surface of the sensor 106. In other examples the means for reducing the sensitivity of the sensor to the angle of incident light may comprise an arrangement of one or more optical components (e.g. one or more lenses) instead of the enclosure 130, where the arrangement of optical components boosts light from higher angles (compared to perpendicular light) by changing the angle of arrival of such light onto the surface of the sensor. In other examples, a plurality of ambient light sensors 106 may be used to achieve an even (or a more even) response. In yet further examples there may be no means for reducing the sensitivity of the sensor to the angle of incident light.

The computing device 110 comprises one or more processors 112 which are microprocessors, controllers or any other suitable type of processors for processing computer executable instructions to control the operation of the device in order to generate display information (which is output to the display device 100). In some examples, for example where a system on a chip architecture is used, the processors 112 include one or more fixed function blocks (also referred to as accelerators) which implement a part of the method of generating display information in hardware (rather than software or firmware). Platform software comprising an operating system 114 or any other suitable platform software may be provided at the computing device to enable application software 116 to be executed on the device.

The computer executable instructions are provided using any computer-readable media that is accessible by the computing device 110. Computer-readable media includes, for example, computer storage media such as memory 118 and communications media. Computer storage media, such as memory 118, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 118) is shown within the computing device 110 it will be appreciated that the storage is, in some examples, distributed or located remotely and accessed via a network or other communication link (e.g. using a communication interface 122).

The memory 118 may be used to store not only the computer-executable instructions for the operating system 114 and application software 116, but also data used by the operating system 114 and/or application software 116, such as calm display calibration data 121 (e.g. brightness and chromaticity calibration data). Although FIG. 1 shows the calibration data 121 as being stored within the computing device 110, in other examples it may be stored elsewhere and may be accessed by the computing device 110 via the communication interface 122. For example, the calm display calibration data 121 may be stored on the display device 100 or a on a remote server (e.g. a cloud-based server).

The computing device 110 also comprises graphics hardware 124 arranged to output display information to the display device 100 which may be separate from or integral to the computing device 110. The display information may provide a graphical user interface and the display information that is output may be calm display information in order that the display device 100 can operate in the calm mode. In examples where the computing device 110 and display device 100 are not co-located and/or the two devices communicate via a network, the graphics hardware 124 may be arranged to output the display information to the display device 100 via the communication interface 122.

The graphics hardware 124 uses gamma lookup tables (LUTs) 120, which may be stored as part of the graphics hardware 124 (e.g. in hardware) or elsewhere (e.g. in memory 118) as a last step of screen content composition. Gamma LUTs 120 were originally intended to compensate for non-linearities in CRT monitors; however, in the methods described herein, they are used for a different purpose, as detailed below.

The computing device 110 may further comprise an input/output controller arranged to receive and process input from one or more devices, such as a user input device (e.g. a mouse, keyboard, camera, microphone, proximity sensor or other sensor). In some examples the user input device detects voice input, user gestures or other user actions and provides a natural user interface (NUI). This user input may be used as an input to the operating system 114 and/or the application software 116, e.g. to control what content is displayed on the display device 100 and/or whether the display is operating in calm mode. In an embodiment the display device 100 also acts as the user input device if it is a touch sensitive display device. The input/output controller may also output data to devices other than the display device, e.g. a locally connected printing device.

Any of the input/output controller, display device 100 and the user input device may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (RGB) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

In various examples, the computing device 110 may be an embedded system.

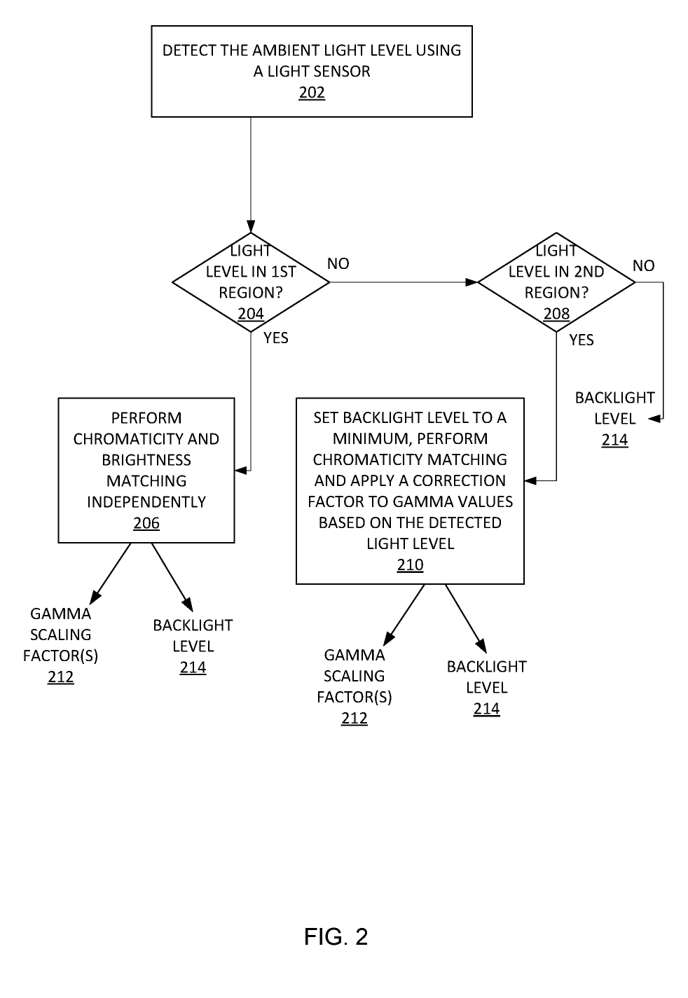

FIG. 2 is a flow diagram of an example method of operation of an emissive display device, such as the display device 100 shown in FIG. 1. This method provides a calm mode of operation (i.e. a mode of operation in which the brightness and chromaticity of the display are closely matched to paper and so the display is less obtrusive to someone nearby) and this mode may be implemented all the time (e.g. such that the display device can be described as a calm display device) or only some of the time. The method may be implemented by an operating system 114 or other software running on a computing device 110 (which may be integral to or separate from the display device 100), e.g. within a calm display module which may be within the operating system 114 or may be separate application software 116. Alternatively, the method may be implemented entirely within the display device 100 (e.g. in software running on the display device 100 and/or in hardware within the display device 100) and in such examples the calm display calibration data 121 (and optionally the gamma LUT 120) may be stored within the display device 100. Although the method is described below as being implemented in software (e.g. with the lookup table data being stored in hardware), in other examples the method may be implemented in hardware.

The method comprises detecting the ambient light level using a light sensor (block 202) and then, dependent upon the detected ambient light level, brightness and chromaticity matching is performed in different ways (blocks 204-210). The brightness and chromaticity matching is performed using calibration data 121 (e.g. brightness and chromaticity calibration data) and methods for generating this calibration data 121 are described below. The outputs from the method are one or more gamma scaling factors 212 (e.g. three gamma scaling factors, one for each primary color) and a backlight brightness level 214 (which may also be referred to as a backlight intensity value). The gamma scaling factors 212 which are output are used as linear coefficients in the gamma lookup table 120 which is used when rendering content onto the display device 100 (i.e. the values in the gamma LUT are multiplied by the scaling factors). The backlight level 214 which is output is used to set the level of the backlight 104 in the emissive display 102.

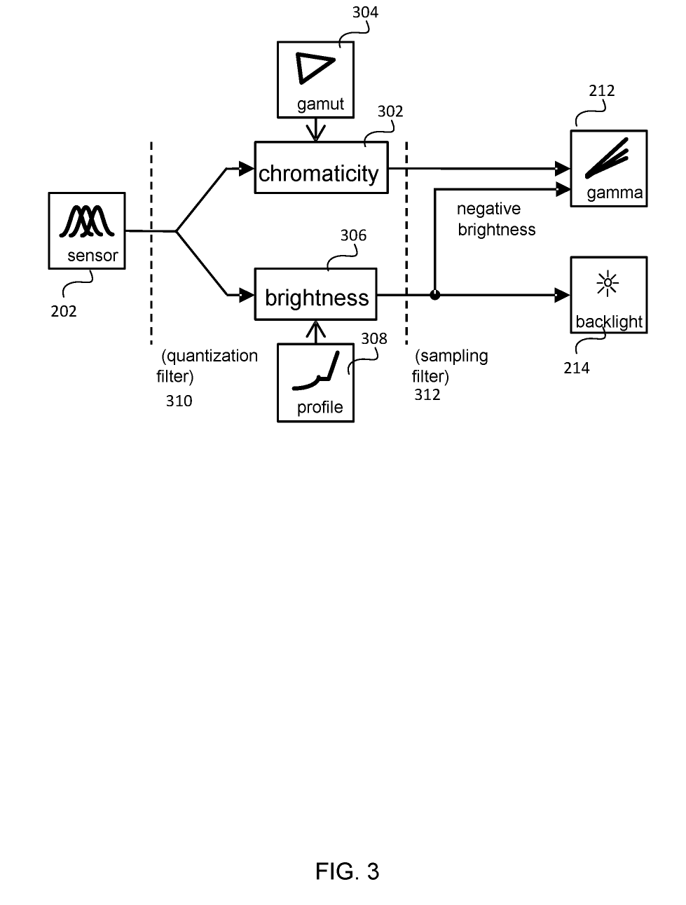

A further representation of the method of FIG. 2 is shown in FIG. 3. This depicts how the chromaticity matching (block 302) is performed based on chromaticity calibration data 304 and the brightness matching (block 306) is performed based on brightness calibration data 308 and how, the gamma scaling factors 212 may be determined independently of the brightness matching (i.e. based only on the chromaticity matching) or may be determined based on both the chromaticity matching and brightness matching (as indicated by the arrow labeled ‘negative brightness’ from block 306 to the gamma scaling factors 212).

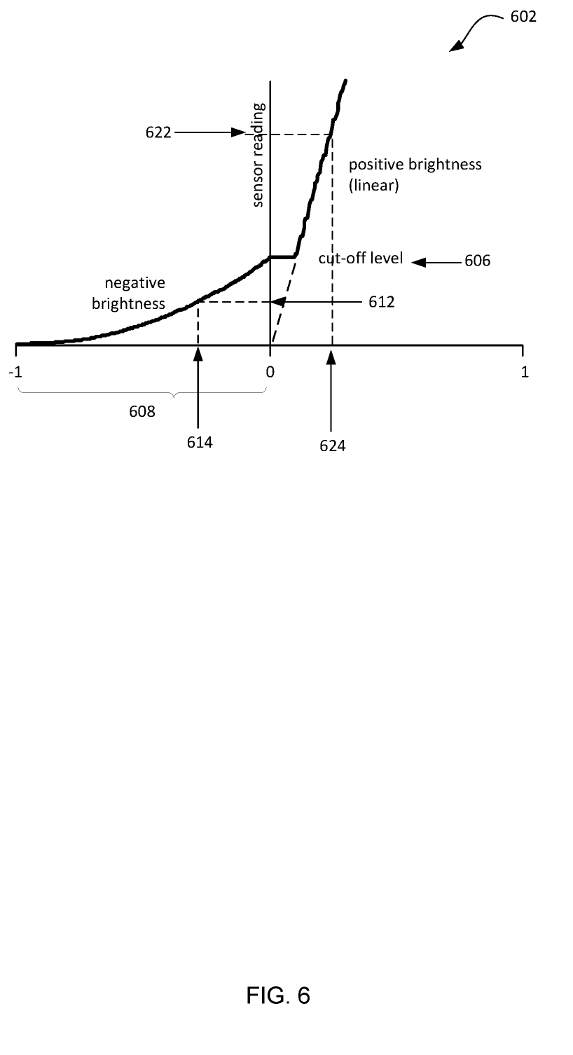

As shown in FIG. 2, if the detected ambient light level is in a first region (‘Yes’ in block 204), then the chromaticity and brightness matching is performed independently of each other (block 206) i.e. the chromaticity matching (which generates one or more gamma scaling factors) is performed totally separately from the brightness matching (which generates a backlight level), except that they are both dependent upon the detected ambient light level. However, if the detected ambient light level is in a second region (‘No’ in block 204 followed by ‘Yes’ in block 208), the chromaticity and brightness matching are not performed independently. Instead, the backlight level is set to a minimum operating level (i.e. a minimum non-zero, or non-off, level), chromaticity matching is performed and the brightness matching affects the gamma scaling factors 212 which are output. In particular, a correction (which is determined using brightness matching and based on the detected ambient light level) is applied to the gamma scaling factors generated using chromaticity matching (block 210). The correction which is applied (in block 210) may be in the form of a multiplicative correction factor or any other transform and various examples are described below. Outside of the first and second regions (‘No’ in block 208), the backlight level 214 may be set using the linear part of the brightness calibration data (e.g. as shown in FIG. 6).

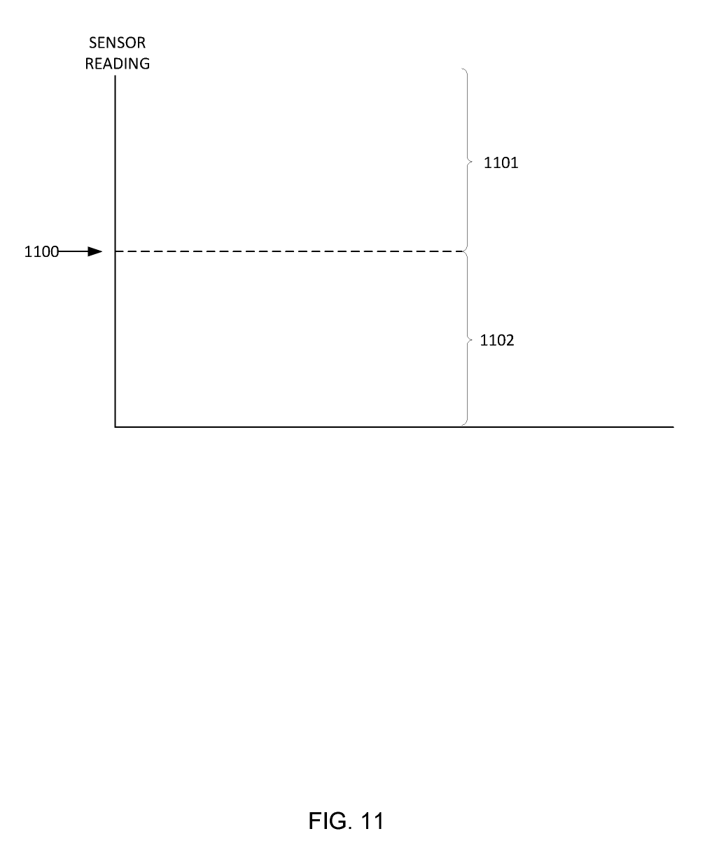

The first and second regions (as used in blocks 204 and 208) may be defined using a single threshold value 1100 (as depicted in FIG. 11), such that detected ambient light levels which exceed a threshold value are considered to be in the first region 1101 and detected ambient light levels which do not exceed the threshold value are considered to be in the second region 1102. Depending upon how the method is implemented, an ambient light level which equals the threshold value 1100 may be considered to be in either the first region or in the second region (but cannot be considered to be part of both regions). In such implementations, the method described herein extends the brightness range that can be achieved by the display device 100 by providing additional darker brightness levels than can be achieved by purely controlling the backlight level (e.g. where the minimum backlight level that can be set is non-zero). By using a correction which is applied to the gamma scaling factors to implement these additional darker brightness levels, the method may be implemented globally, quickly and efficiently (e.g. because the gamma LUTs are implemented in hardware), and independently of the applications which are generating the content that is being displayed. As described below, the correction may alternatively be applied to the RGB values instead of the gamma scaling factors (in block 210). This still provides the additional darker brightness levels than can be achieved by purely controlling the backlight level and the method may be implemented globally and independently of the applications which are generating the content that is being displayed, but as the shaders are implemented in software, the implementation may not be as fast as using a correction to the gamma scaling factors. Additionally the quality that can be achieved using shaders may be less, because, for example, the range may be split into a significantly smaller number of values (e.g. 256 values for software implementations such as using shaders or 65536 values in a hardware LUT).

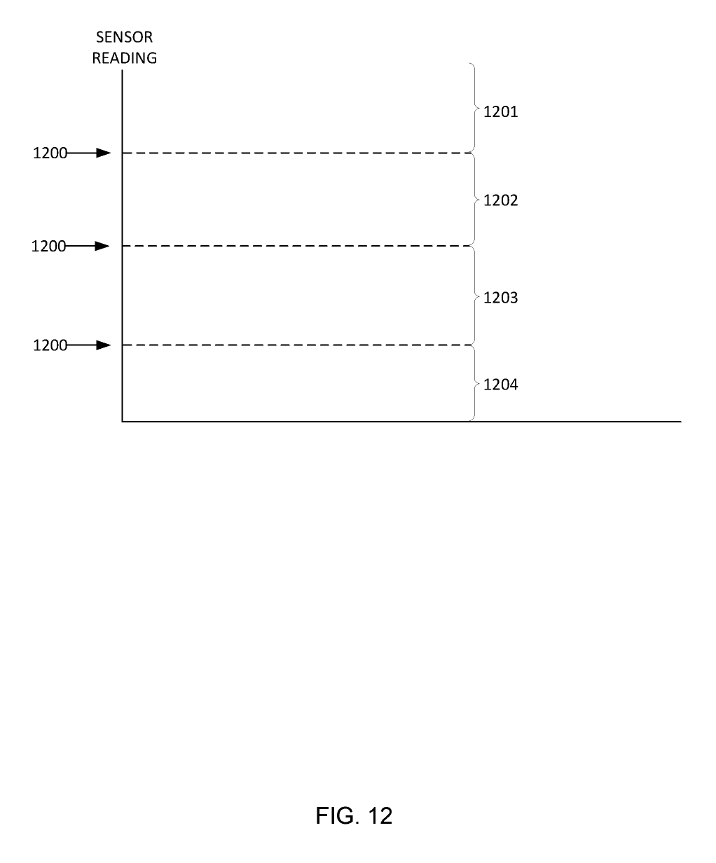

In other examples, there may be more than two regions (as depicted in FIG. 12, e.g. as defined by multiple thresholds 1200) with adjacent regions using different ones of the two methods of calculating gamma scaling factors 212 and backlight level 214 (e.g. such that the third region 1203 uses the same technique as the first region 1201, the fourth region 1204 uses the same technique as the second region 1202 except that the backlight level is not set to a minimum level but to another quantized level, etc.). In such implementations, the method described herein enables a finer granularity of light level control to be achieved than can be achieved by purely controlling the backlight level (e.g. where the granularity of backlight control which is provided is too large). For example, if the backlight is only controllable to quantized levels 4, 3, 2 and 1, to achieve a brightness level of 0.5, the methods described above may be used, i.e. setting the backlight to level 1 and using the gamma table (as described above) to effectively multiply down the brightness by 0.5. Similarly, to achieve a brightness level of 1.5, the backlight level may be set to level 2 and the gamma table used (as described above) to multiply the brightness by 0.75. In such examples, the first region corresponds to a brightness level 1, the third region corresponds to a brightness level 2 and the second region corresponds to brightness levels between levels 1 and 2.

The thresholds 1100, 1200 which are used to define the different regions may be pre-defined and fixed or may vary in some way. In various examples, the value of the threshold that is used to define the first and second regions may vary according to the displayed content and/or the color of the ambient light and/or based on other parameters.

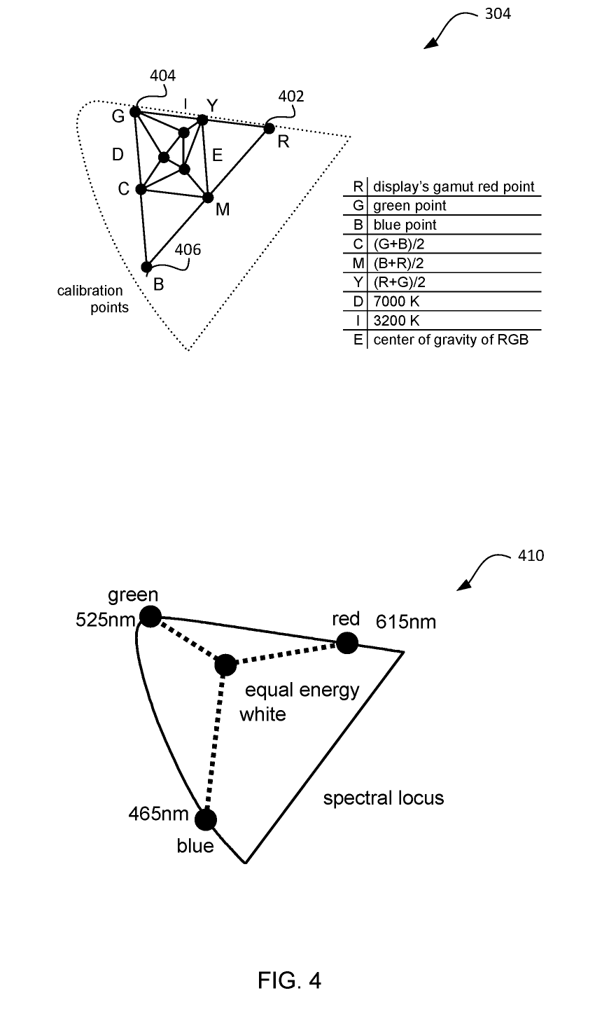

The chromaticity matching (block 302) which is performed (in both blocks 206 and 210) uses chromaticity calibration data 304 and an example of this is shown in FIG. 4. The method uses the CIE 1976 uniform chromaticity scale (UCS), as described in “CIE 15:2004 Colorimetry”, Vienna 2004, due to its perceptual uniformity and continuous nature. Another color space which provides perceptual uniformity may alternatively be used. A color space which provides perceptual uniformity enables colors to be linearly interpolated. However, the method described herein does not rely upon the absolute colorimetric values of the color sensed, but instead only uses the relative position in the color space with respect to the ambient light display's absolute limits 402-406. Consequently, any reference to sensed colors herein are not true colors in the CIE sense but are instead relative colors. In the following description the sensed color space may be referred to as the û′\hat{v}′ space whilst the display output space is referred to as the u′v′ space.

As shown in FIG. 4, the chromaticity calibration data 304 comprises the desired display outputs for a set of given ambient light sensor readings (identified by the circles in the chromaticity calibration data 304) transformed into the u′v′ space, i.e. for a calibration point X (where in the example shown in FIG. 4, X={R, G, B, C, M, Y, D, I, E}), which corresponds to an ambient light sensor reading û_{X}′\hat{v}_{X}′, the calibration data comprises desired display outputs u_{X}′v_{X}′.

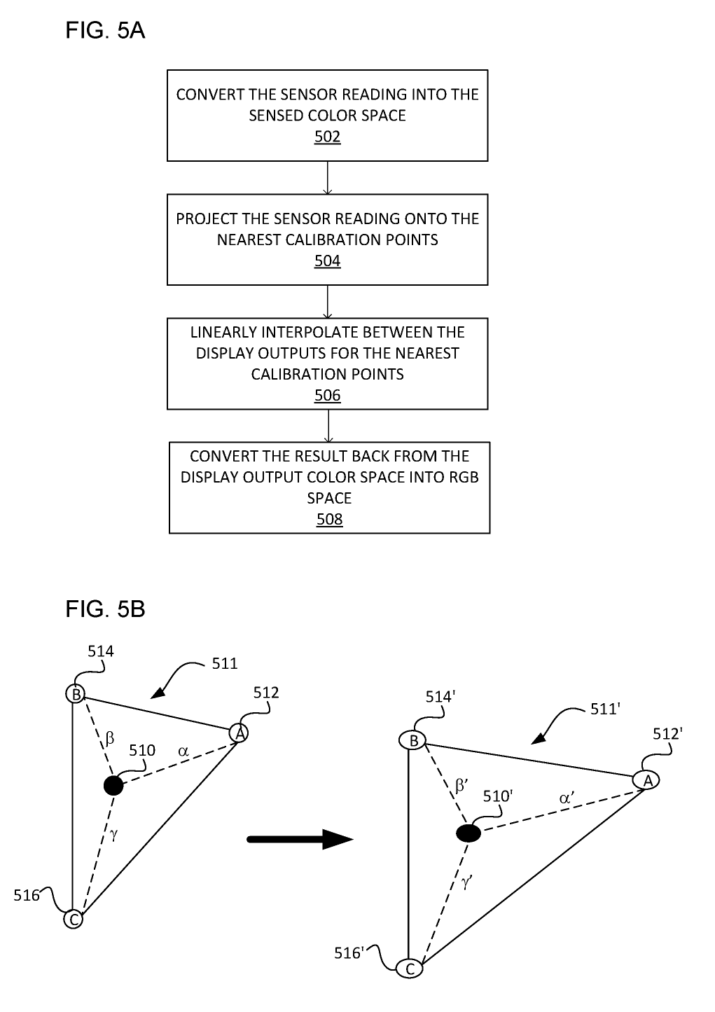

The chromaticity matching (block 302) operation can be described with reference to the diagrams in FIGS. 4 and 5. A sensor reading (from the ambient light sensor 106) is converted into the û′\hat{v}′ space (block 502). This conversion uses the pure colors on the chromaticity diagram's spectral locus corresponding to the peak sensitivity of the sensor's channels as the primaries, e.g. 615 nm, 525 nm and 465 nm in the example chromaticity diagram 410 shown in FIG. 4. The sensor reading in the UV space (i.e. in the sensed color space), û_{S}′\hat{v}_{S}′ (from block 502) is then projected onto the nearest calibration points (block 504). This means that a triangle with vertices at three calibration points that contains the sensed position is identified. This is shown graphically in FIGS. 5A and 5B, with the sensed position (or point) in the û′\hat{v}′ space shown as a solid circle 510. The triangle 511 that is identified (in block 504) has three calibration points 512-516 at its corners (labeled A, B, C) and contains the sensed position 510. If it is not possible to identify a triangle with vertices at three calibration points that contains the sensed position, then the display is not capable of matching the chromaticity exactly and instead the sensed position is modified to be the closest point on any of the triangles with vertices at three calibration points and this provides a best possible chromaticity match.

As described above, for each of the calibration points 512-516 (e.g. û_{A}′\hat{v}_{A}′, û_{B}′\hat{v}_{B}′, û_{C}′\hat{v}_{C}′), the calibration data comprises a desired display output (e.g. u_{A}′v_{A}′, u_{B}′v_{B}′, u_{c}′v_{C}′) and the triangle 511′ in the display space is also shown in FIG. 5B. As shown in FIG. 5B, this triangle 511′ in the display space may be a different shape to the triangle 511 in the sensed space. The display output for the sensed position u_{S}′v_{S}′ is then determined by linearly interpolating between the display outputs for the nearest calibration points 512′-516′ (block 506) such that the sensed position in the display space 510′ is in the same relative position to the triangle 511′ in the display space as the sensed position in the sensed space 510 is to the triangle 511 in the sensed space.

The chromaticity matching (block 302) therefore performs the following transformations (in blocks 502, 504, 506 and 508 respectively): sensor RGB→û′\hat{v}′→u′v′→display RGB

If the sensed ambient light level is in the first region (‘Yes’ in block 204), the final RGB values that are determined from the chromaticity matching (in block 508) are used as linear coefficients (i.e. the gamma scaling factors 212) in the gamma LUTs 120 (as used by the graphics hardware 124). In this way the chromaticity matching is applied globally to all content displayed on the display device 100 without extra computational overhead.

If, however, the sensed ambient light level is in the second region (‘Yes’ in block 208), then a correction factor is applied to these final RGB values (in block 210) and this correction factor is determined using the brightness calibration data as described below. The resulting values are then used as linear coefficients (i.e. the gamma scaling factors 212) in the gamma LUTs 120 (as used by the graphics hardware 124). As in the case for the first region, by using the gamma LUTs the chromaticity matching is applied globally to all content displayed on the display device 100 without extra computational overhead.

An examples of brightness calibration data 602 (or brightness profile) is shown in FIG. 6. As shown in FIG. 6, the built-in backlight control may provide a linear control of the brightness down to a cut-off level 606. The cut-off level 606 is a sensed ambient light level which corresponds to a backlight brightness level for which any lower requested value results in the same backlight brightness. In other examples, however, the control of the backlight 104 above the cut-off level 606 may not be linear but may, for example, be sampled (e.g. such that the profile above the cut-off level 606 resembles a set of steps).

In various examples, the cut-off level 606 defines the threshold which separates the first region and second region (as used in blocks 204 and 208 in FIG. 2). In particular, below the cut-off level 606, the brightness calibration data comprises a ‘negative brightness’ curve 608 which represents the display response when further decreasing the brightness using a multiplicative factor applied to the gamma LUTs. It is this multiplicative factor which is the correction factor that is applied to the final RGB values when the detected ambient level is in the second region (in block 210). In this way, brightness levels lower than the cut-off level 606 can be achieved.

If the detected ambient light level (from block 202) is in the second region (‘Yes’ in block 208), e.g. it is below the cut-off level 606, the correction factor is determined from the negative brightness curve 608. For example, if the detected ambient light level is at a level indicated by arrow 612, then a parameter B (which in this example is negative) is determined using the curve 608 to be a value indicated by arrow 614 and the correction factor (which is between 0 and 1) is given by (1+B).

As described above, if the detected ambient light level (from block 202) is in the second region, e.g. it is below the cut-off level 606, then the correction factor is determined from the part of the brightness calibration data that is the negative brightness curve and the backlight level is set to a minimum (but non-zero) value (block 210). In contrast, the brightness matching (block 306) which is performed when the detected ambient light level is in the first region (in block 206), e.g. if it is above the cut-off level 606, uses the part of the brightness calibration data 308 which is above the cut-off level 606 (e.g. the linear part of the brightness profile). For example, if the detected ambient light level is at a level indicated by arrow 622, then the backlight level is set to a value indicated by arrow 624. In various examples, there may be two or more calibration points above the cut-off level 606 and the brightness matching (in block 206) may interpolate (e.g. linearly interpolate) between the calibration points.

In various examples, one or more filtering operations may be introduced into the method to reduce display flickering. A first optional filtering operation may be included to reduce quantization flicker and a second optional filtering operation may be included to reduce sampling flicker. Quantization flicker is caused by the ambient light level being exactly at the boundary of two digital values reported by the ambient light sensor 106, resulting in a stream of alternating values. The effect of this quantization flicker is more noticeable in lower light conditions. To mitigate quantization flicker, an averaging filter 310 may be placed on the sensor output, as shown in FIG. 3. Sampling flicker is caused by the ambient light source itself. Many light sources exhibit a high-frequency flicker and if the ambient light sensor readings are not synchronized with the light source flicker frequency, lower frequency effects which are visible to the user may be introduced. To mitigate sampling flicker, a smoothing filter 312 may be placed on the output of the method of FIG. 2, as shown in FIG. 3. This smoothing filter 312 blocks small changes in the output. Alternatively, the light flicker frequency may be estimated and the sensing may be synchronized with the flicker.

Although the methods described above use an ambient light level detected by a single ambient light sensor 106, in other examples the display device 110 may comprise a plurality of ambient light sensors 106 which are positioned in different places around the emissive display 102. In such examples, the method of FIG. 2 may operate independently for different portions of the emissive display 102, which each portion of the emissive display 102 being controlled based on a sensed ambient light level detected by a proximate ambient light sensor 106 (e.g. there may be one ambient light sensor per portion of the display).

Although the methods described above output both one or more gamma scaling factors 212 and a backlight level, with a correction being applied to the gamma scaling factors (in block 210) if the detected light level is in the second region (‘Yes’ in block 208), in other examples, the methods may use a global shader (to generate modified RGB values) instead of applying a correction factor to the gamma scaling factors. In such an example, if the detected light level is in the second region (‘Yes’ in block 208), a correction factor is calculated based on the detected light level (as described above) but instead of using this to modify the gamma scaling factor(s), the correction factor is instead input as a parameter to a global shader. The global shader then modifies the RGB values of the pixels to be displayed instead of using the gamma LUTs. In other example, a global shader may be used in combination with gamma LUTs, such that the global shader modifies the RGB values of the pixels prior to application of the gamma LUTs.

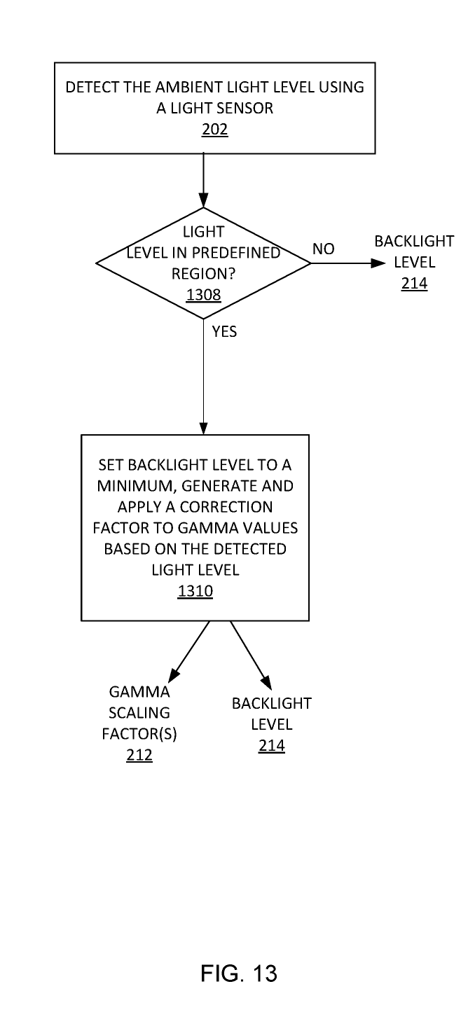

In a further variation on the methods described above, the methods may be used only to perform brightness matching and not chromaticity matching, as shown in FIG. 13. As shown in FIG. 13, if the light level is in a predefined region, i.e. the second region as described above, (‘Yes’ in block 1308), a gamma correction factor is calculated based on the detected light level (using the methods described above) and applied to gamma values (block 1310), but chromaticity matching is not performed. Such a method would use the same light sensor 106 as described above (i.e. one which can detect color and not just brightness). Outside of the pre-defined region (‘No’ in block 1308), the backlight level 214 may be set using the linear part of the brightness calibration data (e.g. as shown in FIG. 6). In such methods where chromaticity matching is not performed, the brightness matching is still improved over known techniques (e.g. those which only rely upon a brightness sensor) because of non-linearities in the display device, light source and/or human perception.

Use of the methods described herein may reduce the power consumption of the display device (e.g. because the backlight level is reduced when in calm mode). Furthermore, use of the methods increases productivity (e.g. because displays do not need to be switched off at night and on again in the morning) and may increase security (e.g. because security updates can be applied more quickly if devices are not manually switched off at night).

The chromaticity and brightness calibration data 304, 308 described above may be generated in any suitable way. Example methods of generating the calibration data are described below which involve a visual comparison (by a human viewer) of the emissive display and a piece of paper under the same lighting conditions. Alternatively, the calibration data may be generated without human involvement and with the visual comparison being performed using two cameras with high spectral accuracy. By using calibration data generated in this way, the emissive display, when operated as described above, not only is ‘calm’ in the sense that it fades into the background, but the colors and brightness used make the content look as if it is rendered on a reflective surface, such as being printed onto paper. As a consequence of the color matching to paper, the methods described herein may reduce eye strain or otherwise make content more accessible to users (e.g. because their eyes do not need to adjust to the unnatural light emitted by the display). In addition, or instead it may help people to sleep better (e.g. by reducing any effect of viewing the display on a viewer's circadian timing).

The calibration data may, in various examples, not be generated for each display device 110 but instead may be generated for a device type, where a device type is defined as a particular combination of sensor type and emissive display type (e.g. because any variation between sensors of the same type and/or emissive displays of the same type will not affect the calibration data significantly).

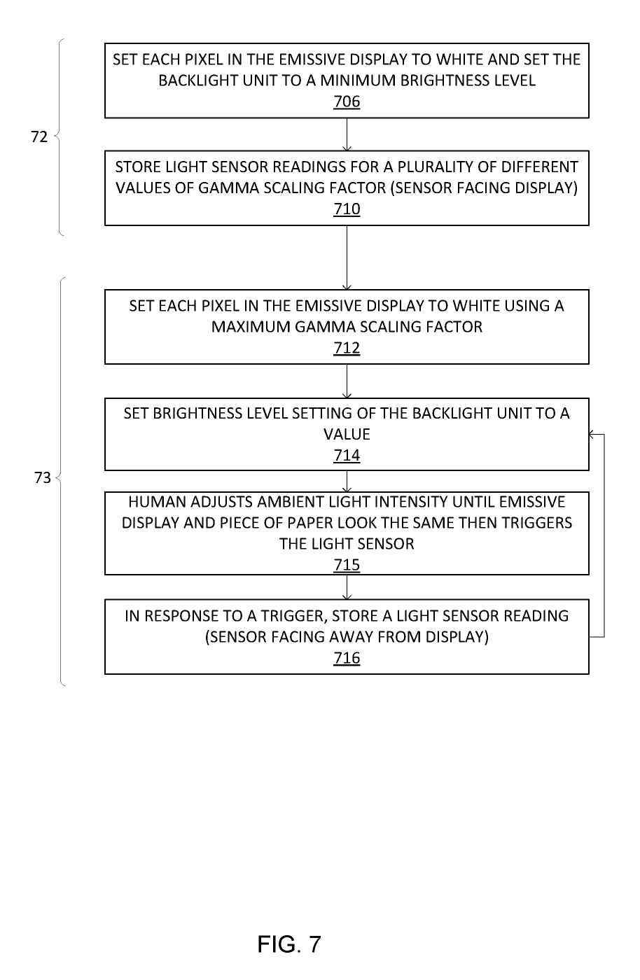

The generation of the brightness calibration data 308 can be described with reference to FIG. 7. The method may be implemented by an operating system 114 or other software running on a computing device 110 (which may be integral to or separate from the display device 100), e.g. within a calm display calibration module which may be within the operating system 114 or may be separate application software 116. The method may be implemented in use (e.g. by a user) or as part of the manufacturing process (e.g. in the manufacturing facility).

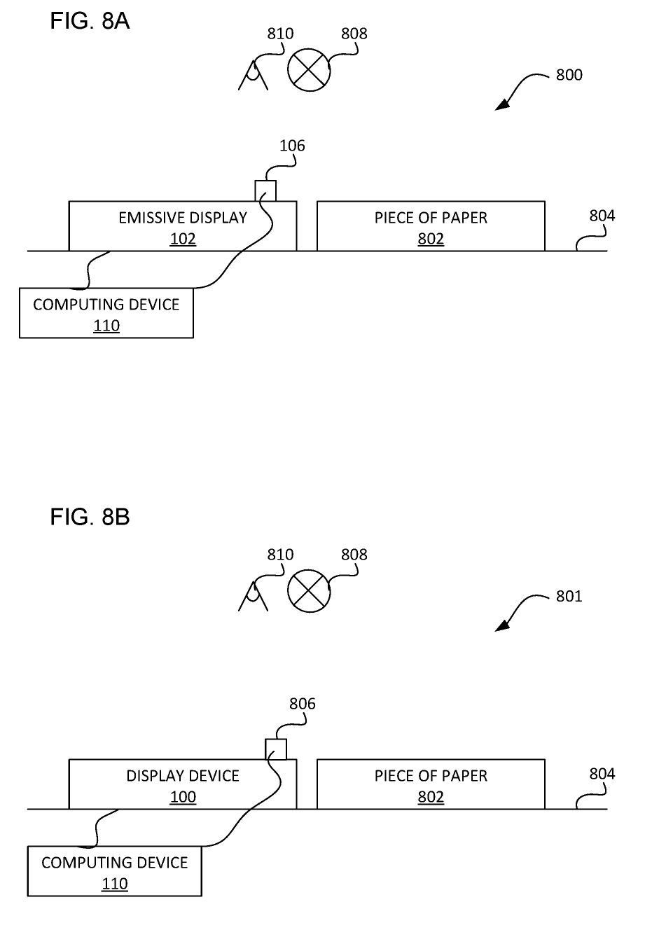

Two examples 800, 801 of the arrangement of hardware which is used for the brightness calibration process are shown in FIGS. 8A and 8B and in each example, the arrangement is shown as viewed from above (i.e. such that the surface 804 is a vertical surface, such as a wall, on which the piece of paper 802 and emissive display 102 are mounted side by side). The first arrangement 800 shown in FIG. 8A may be used where the calibration is performed prior to the assembly of the display device 100 and the second arrangement 801 shown in FIG. 8B may be used on an assembled display device 100. The emissive display 102, or display device 100 comprising the emissive display 102, is positioned, with the display face outwards, beside a piece of paper 802 (e.g. on a flat vertical surface 804). In both arrangements an ambient light sensor 106, 806 is positioned on the front face emissive display 102. In the first arrangement 800 as shown in FIG. 8A, this light sensor 106 is the ambient light sensor that will be assembled into the display device 100 or a light sensor of the same type as the ambient light sensor that will be assembled into the display device 100. In the second arrangement 801 as shown in FIG. 8B, the light sensor 806 is of the same type as the ambient light sensor 106 within the display device 100.

Although FIGS. 8A and 8B show a single ambient light sensor in each arrangement, in various examples two ambient light sensors of the same type may be used (e.g. one which is integral to the display device 100 and one which is separate from the display device 100, or two separate ambient light sensors) with one positioned facing the emissive display surface (i.e. to sense light emitted by the emissive display) and the other position facing away from the emissive display surface (i.e. to sense ambient light falling on the emissive display).

The emissive display 102/display device 100 and the ambient light sensor(s) 106, 806 are connected to a computing device 110 which generates the brightness calibration data 308. This computing device 110 may be the same as the computing device 110 which implements the methods described above with reference to FIG. 2 or may be a different computing device (e.g. a computing device which is dedicated to generating the calibration data). Both the emissive display 102/display device 100 and the piece of paper 802 are illuminated by a controllable light source 808. The controllable light source 808 has an intensity (or brightness) which can be varied by a user, e.g. by changing the intensity of the source itself, by changing the separation of the light source and the surface 804 or by inserting filters in front of the light source. An example viewing position 810 of a user is also shown in FIGS. 8A and 8B.

As shown in FIG. 7, the generation of the brightness calibration data 308 comprises two stages 72 and 73. The first stage 72 generates the negative brightness curve 608 and the second stage 73, which is the part that involves user interaction, provides data linking human perception and the ambient light sensor readings and generates the part of the brightness calibration data above the cut-off level 606.

In the first stage 72, the backlight unit 104 in the emissive display 102 is set to a minimum brightness level (block 706), e.g. so that it is operating at the cut-off level 606, and light sensor readings are stored for a plurality of different values of gamma scaling factor between 0 and 1 (block 710). The ambient light sensor which is used in this first stage is facing the emissive display 102 such that it senses light emitted by the emissive display 102 and the measured values may be considered to be brightness levels. The first stage 72 generates at least two data pairs, each comprising a light sensor reading (where this reading corresponds to light emitted by the emissive display), S_{E}, and a gamma scaling factor, G. Having generated all the data pairs, the light sensor readings are scaled to a relative scale from 0 to 1 (i.e. by dividing each reading by the maximum light sensor reading). This generates the negative brightness curve comprising a monatonic curve going from (0,0) to (1,1). In the examples described herein, however, the convention uses negative values and hence one may be subtracted from each of the values to generate a monatonic curve going from (−1,−1) to (0,0).

The second stage 73 provides a link between the performance of the emissive display 102 and how a human perceives the display. As shown in FIG. 7, the second stage 73 starts by setting each pixel in the emissive display 102 to white using a maximum gamma scaling factor (block 712). The backlight unit 104 is then set to a first brightness level setting (block 714), e.g. to a minimum setting, and a user adjusts the level of ambient light (by adjusting the position and/or intensity of the controllable light source 808) until the emissive display 102 looks the same as the piece of paper 802. When they look the same, the user triggers the light sensor (block 715). In this second stage 73, the light sensor which is triggered is facing away from the emissive display 102 (such that it senses ambient light falling on the emissive display 102 instead of light emitted by the emissive display 102). In response to a trigger, a first ambient light sensor reading is stored (block 716). The backlight unit 104 is then set to a second brightness level setting (in block 714), e.g. to a maximum setting, and a user again adjusts the level of ambient light (by adjusting the position and/or intensity of the controllable light source 808) until the emissive display 102 looks the same as the piece of paper 802. If the light cannot match the full brightness of the display (in block 714), then the brightness of the display may be adjusted to match the level of the light. When the emissive display 102 and the piece of paper 802 look the same, the user triggers the light sensor and in response to a trigger, a second ambient light sensor reading is stored (in block 716). In various examples, blocks 714-716 may be further repeated to capture more than two ambient light sensor readings. The output of the second stage 73, is therefore the part of the brightness calibration curve above the cut-off level 606.

Finally, the two parts of the calibration curve are combined by using the cut-off brightness level (from the second stage) to scale the y-values of negative brightness curve (which, as generated in the first stage, range from −1 to 0), thereby obtaining a negative brightness curve 608 as shown in FIG. 6.

The light sensor readings which are stored in the method described above with reference to FIG. 7 may be the clear channel sensed values or alternatively the RGB values may be used instead.

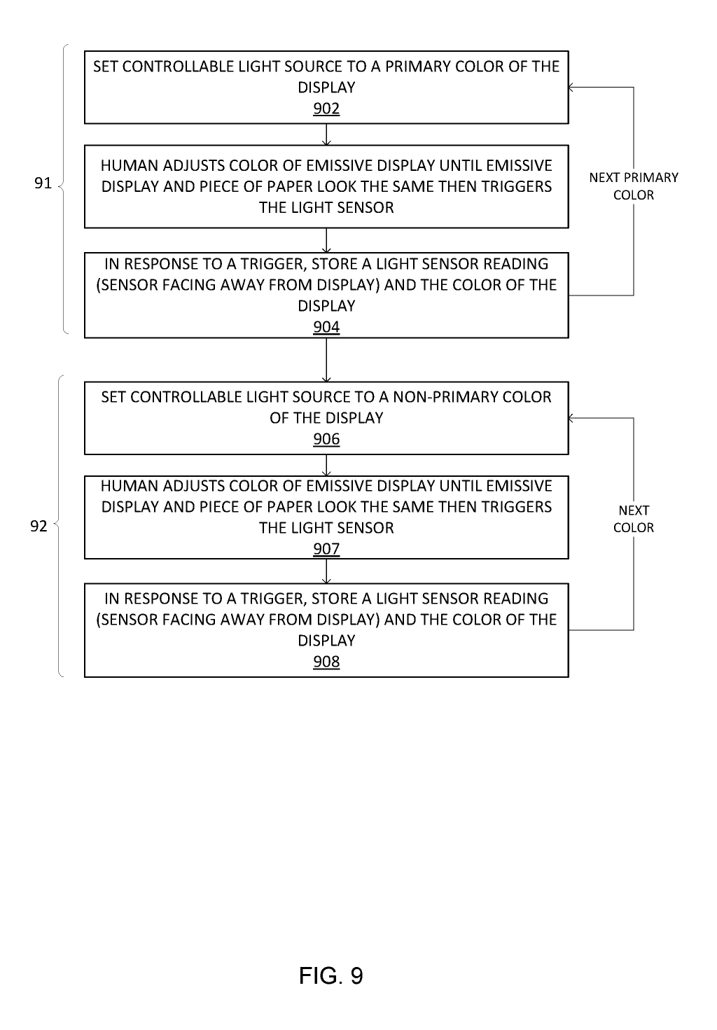

The generation of the chromaticity calibration data 304 can be described with reference to FIG. 9. The method may be implemented by an operating system 114 or other software running on a computing device 110 (which may be integral to or separate from the display device 100), e.g. within a calm display calibration module which may be within the operating system 114 or may be separate application software 116. The arrangement of hardware used for the chromaticity calibration process may be the same as for the brightness calibration process and two examples 800, 801 are shown in FIGS. 8A and 8B. When performing chromaticity calibration, however, the controllable light source 808 has a color which can be varied by a user (the intensity of the light source 808 may or may not be varied by the user).

The first arrangement 800 shown in FIG. 8A may be used where the calibration is performed prior to the assembly of the display device 100 and the second arrangement 801 shown in FIG. 8B may be used on an assembled display device 100. The emissive display 102, or display device 100 comprising the emissive display 102, is positioned, with the display face outwards, beside a piece of paper 802 (e.g. on a flat vertical surface 804). In both arrangements an ambient light sensor 106, 806 is positioned on the front surface of the emissive display 102. In the first arrangement 800 shown in FIG. 8A, this light sensor 106 is the ambient light sensor that will be assembled into the display device 100 or a light sensor of the same type as the ambient light sensor that will be assembled into the display device 100. In the second arrangement 801 shown in FIG. 8B, the light sensor 806 is of the same type as the ambient light sensor 106 within the display device 100.

As shown in FIG. 9, the generation of the chromaticity calibration data 304 comprises two stages 91-92 and although the stages are shown as being performed in a particular order in FIG. 9, in other examples they may be performed in the opposite order. The first stage 91 generates the calibration points for the red, green and blue primaries (calibration points 402-406 labeled R, G, B in the example shown in FIG. 4) and the second stage 92 generates a plurality of other calibration points on the triangle formed by the three primaries (e.g. calibration points labeled C, M, Y in the example shown in FIG. 4) as well as within the triangle (e.g. calibration point E) and at or close to the white points (e.g. calibration points labeled D, I in the example shown in FIG. 4).

As shown in FIG. 9, each calibration point is generated by setting the controllable light source to a color (blocks 902 and 906) e.g. to a primary color of the display in block 902 or to a non-primary color of the display in block 906. A user then adjusts the color of the emissive display (by adjusting the gamma scaling factor and/or RGB settings (and optionally brightness too) until the emissive display 102 looks the same as the piece of paper 802. When they look the same, the user triggers the light sensor (block 907). In response to a trigger, an ambient light sensor reading is stored along with the current color of the display (blocks 904 and 908). The data which is stored (in blocks 904 and 908) for each calibration point is a data pair comprising two RGB values, one detected by the ambient light sensor and the other corresponding to the color of the emissive display. These values are converted to the uniform chromaticity scale prior to being stored and may be denoted û_{X}′\hat{v}_{X}′ for the ambient light sensor reading and u_{X}′v_{X}′ for the display color.

The methods shown in FIGS. 7 and 9 and described above show complete methods of generating both the brightness and the chromaticity calibration data. In various examples, some of this data may be available from the manufacturer of the display and/or light sensor and so some of the steps of the methods may be omitted. For example, if the display is linear and the primaries are known (e.g. provided by the manufacturer of the display) or can be estimated or measured, the chromaticity calibration can be omitted.

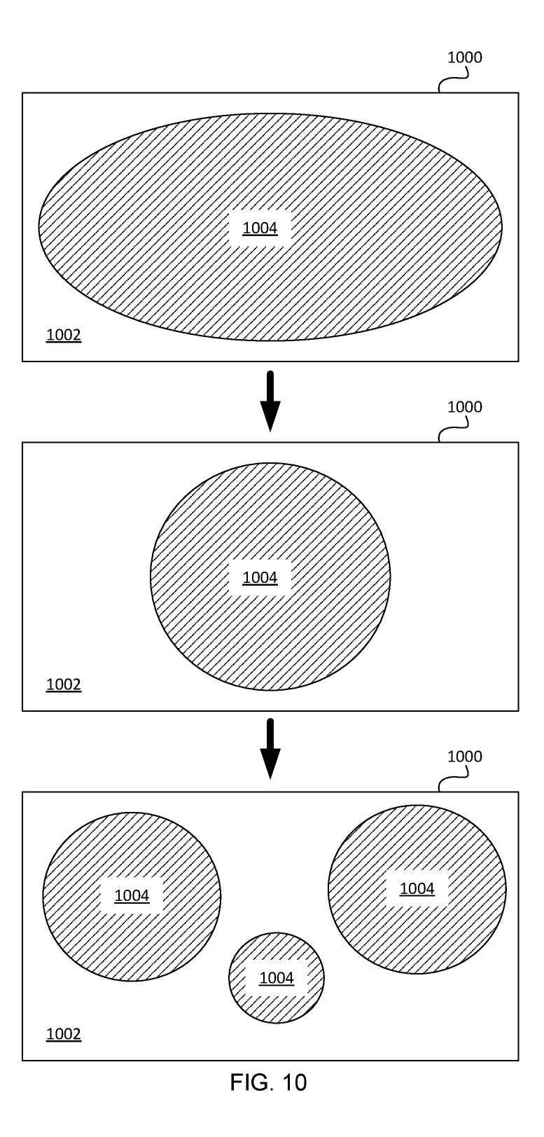

The methods of operation of an emissive display device described above with reference to FIG. 2 (i.e. the calm mode of operation) may be implemented across every pixel in a display. In other examples, however, the methods may be implemented for a subset of the pixels in the emissive display 102 and this may, for example, be used to modify the apparent shape of the display. This can be described with reference to FIG. 10 which shows a schematic diagram of an emissive display 1000. The emissive display 1000 shown in FIG. 10 is rectangular and most emissive displays which are produced are rectangular in shape. This shape is, at least in part, a consequence of the row-column arrangement of pixels and the driver circuitry, as well as the additional complexity and cost associated with fabricating displays which are different, and possibly irregular, shapes.

In various examples, the methods described herein (i.e. the calm mode of operation) may be used for a plurality of pixels around the edge of the display 1000 (e.g. those pixels in region 1002 in FIG. 10) and those pixels in the center of the display (e.g. those pixels in region 1004) may be operated in a standard way (i.e. not in calm mode). In this way, the outer border of the display (e.g. region 1002) will be less obtrusive and fade into the background whereas the center portion (e.g. region 1004) will stand out and the display will appear to be elliptical in shape.

By changing the shapes of the two regions 1002, 1004, not only can the display 1000 appear to have a non-rectangular shape, but the apparent shape of the display 1000 can be varied over time and the displays may be made to appear to move and in some examples, the display 1000 may appear to be a plurality of smaller displays.

As described above, using the method of FIG. 2 (i.e. the calm mode of operation), the overall power consumption of the display device 100 may be reduced (e.g. because the backlight brightness level is generally lower than it would be if the calm mode of operation was not used and instead the emissive display 102 was operated in the standard way. In order to further reduce the power consumption of the display device 100, it may comprise a presence sensor (e.g. a PIR sensor, Doppler radar sensor, thermopile, etc.) and the backlight 104 (and optionally the entire emissive display 102) may be switched off when the presence sensor does not sense anyone. If the presence sensor subsequently detects someone, then the backlight 104 (and the entire emissive display 102 if that was previously switched off) may be switched back on and operated as described above with reference to FIG. 2 (i.e. in the calm mode of operation). In various examples only part of the emissive display 102 (and/or backlight 104) may be switched back on (and operated as described with reference to FIG. 2) in response to the presence sensor detecting someone and the remainder of the emissive display 102 (and/or backlight 104) may be switched back on in response to user input and/or dependent on the content being displayed on the emissive display 102. Although the presence sensor is described as being part of the display device 100, in other examples it may be a separate device which is positioned proximate to the display device 100 and which is in communication with the display device 100 and/or the computing device 110.

In further examples, a more intelligent sensing system may be used instead of one or more presence sensors. For example, the system may comprise one or more cameras (e.g. in communication with, or integral to, the display device 100 and/or the computing device 110) and the computing device 110 may comprise image processing software configured to determine whether a user is looking (e.g. based on eye tracking) or facing (e.g. based on tracking body position) towards the display device 100 or not, and to switch the emissive display 102 (and/or backlight 104) on and off, or to switch between normal mode and calm mode, in response to this determination (e.g. to switch the emissive display 102 off if the user is determined to not be looking or facing towards the display device and to switch the emissive display 102 on if the user is determined to be looking or facing towards the display device, where when switched on, the display device 100 in combination with the computing device 110 operates as described above with reference to FIG. 2).

In the description above, the method of FIG. 2 is described as being mainly implemented in software (e.g. as part of the operating system 114). Alternatively, or in addition, the functionality described herein may be performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

Although the present examples are described and illustrated herein as being implemented in a system as shown in FIG. 1, the system described is provided as an example and not a limitation. As those skilled in the art will appreciate, the present examples are suitable for application in a variety of different types of computing systems.

Further examples are described below and additional examples may comprise various combinations of the following features. Features may be combined in any manner (e.g. such that an example may comprise any subset of the features of the first further example set out below or any subset of the features of the third further example set out below).

A first further example provides a method of operating an emissive display, the method comprising: detecting an ambient light level using a light sensor; and in response to detecting an ambient light level in a predefined region, setting a backlight level to a minimum level, generating a correction factor based on the detected ambient light level and modifying color values of pixels using the correction factor.

The method of the first further example may further comprise: in response to detecting an ambient light level in the predefined region, additionally performing chromaticity matching.

The predefined region may be a second region and the method of the first further example may further comprise: in response to detecting an ambient light level in a first region, performing chromaticity and brightness matching independently. Performing brightness matching for a detected ambient light level in the first region may comprise: accessing brightness calibration data, the brightness calibration data comprising a negative brightness curve defining calibration factors for ambient light levels below a cut-off level; and determining a calibration factor corresponding to the detected ambient light level based on the negative brightness curve in brightness calibration data.

In the method of the first further example modifying color values of content to be displayed using the correction factor may comprise: applying the correction factor to one or more gamma scaling factors output from the chromaticity matching to generate modified gamma scaling factors.

The predefined region may be a second region and the method of the first further example may further comprise: comparing the detected ambient light level to a threshold, wherein if the detected ambient light level exceeds the threshold, the ambient light level is in the first region and if the detected ambient light level does not exceed the threshold, the ambient light level is in the second region. The threshold may be determined based on a minimum, non-zero brightness level of the emissive display. The threshold may be determined based on a minimum, non-zero brightness level of a backlight unit in the emissive display.

In the method of the first further example performing chromaticity matching may comprise: converting sensor data from the ambient light sensor into an additive color space; accessing chromaticity calibration data and projecting the converted sensor data onto a closest triangle formed by three calibration points in the chromaticity calibration data; linearly interpolating between display output data for each of the three calibration points to generate a display output data point for the converted sensor data; and converting the display output data point back into RGB color space from the additive color space to generate one or more gamma scaling factors. The additive color space may be a CIE 1976 UCS.

In the method of the first further example generating a correction factor based on the detected ambient light level may comprise: accessing brightness calibration data; and determining a backlight level corresponding to the detected ambient light level based on the brightness calibration data.

The method of the first further example may further comprise: generating brightness calibration data. Generating the brightness calibration data may comprise: setting each pixel in the emissive display to white and setting a backlight in the emissive display to a minimum brightness level; adjusting a gamma scaling factor used to generate display information output to the emissive display and storing light sensor readings for a plurality of different values of gamma scaling factor, wherein the light sensor is positioned such that it captures light emitted by the emissive display such that each stored light sensor reading is a detected emitted light level; setting each pixel in the emissive display to white using a maximum gamma scaling factor; setting a brightness level setting of the backlight to a first value; in response to a user initiated trigger, storing a first data pair comprising the first value and a light sensor reading, wherein the light sensor is positioned such that it captures ambient light falling on the emissive display such that the light sensor reading is a first detected ambient light level; setting a brightness level setting of the backlight to a second value; in response to a user initiated trigger, storing a second data pair comprising the second value and a second detected ambient light level; and generating a first part of the brightness calibration data by converting the detected emitted light levels for the plurality of different gamma scaling factors to a plurality of data points specifying gamma scaling factors for a plurality different detected ambient light levels using at least the first and second data pairs.

The method of the first further example may further comprise generating chromaticity calibration data. Generating the chromaticity calibration data may comprise: setting a controllable light source to a primary color; in response to a user initiated trigger, storing a first color calibration point comprising the color of the controllable light source and a light sensor reading, wherein the light sensor is positioned such that it captures ambient light falling on the emissive display such that the light sensor reading is a detected ambient light color value; and repeating the setting and storing, in response to a user initiated trigger, to store a plurality of other color calibration points at two other primary colors and a plurality of non-primary colors.

A second further example provides a method of operating an emissive display, the method comprising: detecting an ambient light level using a light sensor; in response to detecting an ambient light level in a first region, performing chromaticity and brightness matching independently; and in response to detecting an ambient light level in a second region, setting a backlight level to a minimum level, performing chromaticity matching, generating a correction factor based on the detected ambient light level and modifying color values of pixels using the correction factor.

A third further example provides a system comprising a computing device, the computing device comprising: a processor; graphics hardware configured to output display information to a display device comprising an emissive display and an ambient light sensor; and a memory arranged to store computer-executable instructions, that when executed by the processor, cause the computing device to: detect an ambient light level using an ambient light sensor; and in response to detecting an ambient light level in a predefined region, set a backlight level to a minimum level, generate a correction factor based on the detected ambient light level and modify color values of content to be displayed using the correction factor.

In the third further example the computing device may be further arranged to store chromaticity calibration data and wherein the memory may be further arranged to store computer-executable instructions, that when executed by the processor, cause the computing device to: in response to detecting an ambient light level in the predefined region, additionally performing chromaticity matching.

In the third further example the predefined region may be a second region and the memory may be further arranged to store computer-executable instructions, that when executed by the processor, cause the computing device to:

in response to detecting an ambient light level in a first region, performing chromaticity and brightness matching independently.

In the third further example the system may further comprise the display device, the display device comprising: an emissive display comprising a backlight; and the ambient light sensor. The ambient light sensor may comprise means for attenuating perpendicular light.

In the third further example the computing device may be further arranged to store gamma lookup tables and wherein modifying color values of content to be displayed using the correction factor may comprise: applying the correction factor to one or more gamma scaling factors output from the chromaticity matching to generate modified gamma scaling factors.

In the third further example generating a correction factor based on the detected ambient light level may comprise: accessing brightness calibration data; and determining a backlight level corresponding to the detected ambient light level based on the brightness calibration data.

A fourth further example provides one or more tangible device-readable media with device-executable instructions that, when executed by a computing system, direct the computing system to perform operations comprising: detecting an ambient light level using a light sensor; and in response to detecting an ambient light level in a predefined region, setting a backlight level to a minimum level, generating a correction factor based on the detected ambient light level and modifying color values of content to be displayed using the correction factor.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A method of operating an emissive display, the method comprising:
detecting an ambient light level using a light sensor; and
in response to detecting an ambient light level in a predefined region, setting a backlight level to a minimum level, generating a correction factor based on the detected ambient light level and modifying color values of pixels using the correction factor.

2. The method according to claim 1, further comprising:
in response to detecting an ambient light level in the predefined region, additionally performing chromaticity matching.

3. The method according to claim 1, wherein the predefined region is a second region and the method further comprises:
in response to detecting an ambient light level in a first region, performing chromaticity and brightness matching independently.

4. The method according to claim 3, wherein performing brightness matching for a detected ambient light level in the first region comprises:
accessing brightness calibration data, the brightness calibration data comprising a negative brightness curve defining calibration factors for ambient light levels below a cut-off level; and
determining a calibration factor corresponding to the detected ambient light level based on the negative brightness curve in brightness calibration data.

5. The method according to claim 1, wherein modifying color values of content to be displayed using the correction factor comprises:
applying the correction factor to one or more gamma scaling factors output from the chromaticity matching to generate modified gamma scaling factors.

6. The method according to claim 1, wherein the predefined region is a second region and the method further comprises:
comparing the detected ambient light level to a threshold,
wherein if the detected ambient light level exceeds the threshold, the ambient light level is in the first region and if the detected ambient light level does not exceed the threshold, the ambient light level is in the second region.

7. The method according to claim 6, wherein the threshold is determined based on a minimum, non-zero brightness level of the emissive display.

8. The method according to claim 1, wherein performing chromaticity matching comprises:
converting sensor data from the ambient light sensor into an additive color space;
accessing chromaticity calibration data and projecting the converted sensor data onto a closest triangle formed by three calibration points in the chromaticity calibration data;
linearly interpolating between display output data for each of the three calibration points to generate a display output data point for the converted sensor data; and
converting the display output data point back into RGB color space from the additive color space to generate one or more gamma scaling factors.

9. The method according to claim 1, wherein generating a correction factor based on the detected ambient light level comprises:
accessing brightness calibration data; and
determining a backlight level corresponding to the detected ambient light level based on the brightness calibration data.

10. The method according to claim 1, further comprising:
generating brightness calibration data.

11. The method according to claim 10, wherein generating the brightness calibration data comprises:
setting each pixel in the emissive display to white and setting a backlight in the emissive display to a minimum brightness level;
adjusting a gamma scaling factor used to generate display information output to the emissive display and storing light sensor readings for a plurality of different values of gamma scaling factor, wherein the light sensor is positioned such that it captures light emitted by the emissive display such that each stored light sensor reading is a detected emitted light level;
setting each pixel in the emissive display to white using a maximum gamma scaling factor;
setting a brightness level setting of the backlight to a first value;
in response to a user initiated trigger, storing a first data pair comprising the first value and a light sensor reading, wherein the light sensor is positioned such that it captures ambient light falling on the emissive display such that the light sensor reading is a first detected ambient light level;
setting a brightness level setting of the backlight to a second value;
in response to a user initiated trigger, storing a second data pair comprising the second value and a second detected ambient light level; and
generating a first part of the brightness calibration data by converting the detected emitted light levels for the plurality of different gamma scaling factors to a plurality of data points specifying gamma scaling factors for a plurality different detected ambient light levels using at least the first and second data pairs.

12. The method according to claim 1, further comprising generating chromaticity calibration data by:
setting a controllable light source to a primary color;
in response to a user initiated trigger, storing a first color calibration point comprising the color of the controllable light source and a light sensor reading, wherein the light sensor is positioned such that it captures ambient light falling on the emissive display such that the light sensor reading is a detected ambient light color value; and
repeating the setting and storing, in response to a user initiated trigger, to store a plurality of other color calibration points at two other primary colors and a plurality of non-primary colors.

13. A system comprising a computing device, the computing device comprising:
a processor;
graphics hardware configured to output display information to a display device comprising an emissive display and an ambient light sensor; and
a memory arranged to store computer-executable instructions, that when executed by the processor, cause the computing device to:
detect an ambient light level using an ambient light sensor; and
in response to detecting an ambient light level in a predefined region, set a backlight level to a minimum level, generate a correction factor based on the detected ambient light level and modify color values of content to be displayed using the correction factor.

14. The system according to claim 13, wherein the computing device is further arranged to store chromaticity calibration data and wherein the memory is further arranged to store computer-executable instructions, that when executed by the processor, cause the computing device to:
in response to detecting an ambient light level in the predefined region, additionally performing chromaticity matching.

15. The system according to claim 13, wherein the predefined region is a second region and the memory is further arranged to store computer-executable instructions, that when executed by the processor, cause the computing device to:
in response to detecting an ambient light level in a first region, performing chromaticity and brightness matching independently.

16. The system according to claim 13, further comprising the display device, the display device comprising:
an emissive display comprising a backlight; and
the ambient light sensor.

17. The system according to claim 16, wherein the ambient light sensor comprises means for attenuating perpendicular light.

18. The system according to claim 13, wherein the computing device is further arranged to store gamma lookup tables and wherein modifying color values of content to be displayed using the correction factor comprises:
applying the correction factor to one or more gamma scaling factors output from the chromaticity matching to generate modified gamma scaling factors.

19. The system according to claim 13, wherein generating a correction factor based on the detected ambient light level comprises:
accessing brightness calibration data; and
determining a backlight level corresponding to the detected ambient light level based on the brightness calibration data.

20. One or more tangible device-readable media with device-executable instructions that, when executed by a computing system, direct the computing system to perform operations comprising:
detecting an ambient light level using a light sensor; and
in response to detecting an ambient light level in a predefined region, setting a backlight level to a minimum level, generating a correction factor based on the detected ambient light level and modifying color values of content to be displayed using the correction factor.
